(19) United States
(12) Patent Application Publication
(10) Pub. No.: US 2007/0296925 A1
(43) Pub. Date: Dec. 27, 2007

(54) ILLUMINATION SYSTEM AND PROJECTION SYSTEM

(76) Inventors: Chi-Wei Huang, Taipei City (TW); Sung-Tse Yang, Taichung City (TW); Shun-Yi Chen, Chiayi County (TW); Mei Liu, Pingtung County (TW); Wen-Chih Tai, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,132

(22) Filed: Jun. 27, 2006

(51) Int. Cl. G03B 21/14

(52) U.S. Cl. 353/38

(57) ABSTRACT

An illumination system including a light source module, a first integral lens array, a cylindrical lens array, a polarization beam splitter converter, a cylindrical lens, a condenser lens, and a collimator lens is provided. The light source module is suitable for providing a white light, and the first integral lens array, the cylindrical lens array, the polarization beam splitter converter, the cylindrical lens, the condenser lens, and the collimator lens are sequentially disposed on a optical path of the white light. Thus, the cylindrical lens array can adjust the shape of the light spots which are formed by focusing the white light for the light spots nearly completely passing through the polarization beam splitter converter to increase the light utilization of the illumination system. Additionally, a projection system including the illumination system mentioned above and a liquid crystal display panel is also provided.

### BACKGROUND OF THE INVENTION

1. Field of the Invention

The present invention relates to an illumination system and a projection system, and more particularly, to an illumination system and a projection system with a better light utilization.

2. Description of the Related Art

Along with the progress of contemporary video technology, the projection apparatus is widely applied in various occasions for providing larger image, such as a meeting room, convention center, and theater. Essentially, in order to project a clear image, the illumination system of the projection apparatus requires the light source with higher illumination. However, a poor-quality light utilization of the illumination system leads to insufficient illumination, significantly deteriorating the image quality of the projection apparatus and cause a burly image. Consequently, how to effectively improve the light utilization of the illumination system has become an important issue in the field.

FIG. 1 is a schematic side view of a conventional illumination system. Referring to FIG. 1, the conventional illumination system 100 comprises a light source module 110, a first integral lens array 120, a second integral lens array 130, a polarization beam splitter converter 140, a condenser lens 150, and a collimator lens 160. The light source module 110 is suitable for providing a white light 112, and the first integral lens array 120, the second integral lens array 130, the polarization beam splitter converter 140, the condenser lens 150, and the collimator lens 160 are sequentially disposed on the optical path of the white light 112.

Firstly, the white light 112 is focused on the polarization beam splitter converter 140 by the first integral lens array 120 and the second integral lens array 130. Then, the white light 112 is converted into a polarized light by the polarization beam splitter converter 140 and, then the white light 112 is focused on the collimator lens 160 by the condenser lens 150 and then converted to a nearly parallel light beam by the collimator lens 150. In addition, if a liquid crystal display panel 102 is disposed on the optical path of the white light 112 after the collimator lens 160, the illumination system 100 and the liquid crystal display panel 102 together constitute a projection system 10.

However, a 1.1 mm arc gap in the lamp wick is required due to the limitation of the current manufacturing technique; therefore, the white light 112 provided by the light source module 110 could not be an ideal parallel light beam. Additionally, the first integral lens array 120 cannot focus the white light 112 as an ideal dot light source, rather than that the white light 112 focused by the first integral lens array 120 forms a light spot with a certain scale rather than a single small point. If the second integral lens array 130 is not configured, the white light 112 cannot be directly focused on the polarization beam splitter converter 140 after passing through the first integral lens array 120. In this case, the light spot with larger scale is blocked by the polarization beam splitter converter 140. Accordingly, the light utilization of the illumination system 100 is decreased, wherein the light utilization is a ratio of the illumination of the white light 112 finally provided by the illumination system 100 to the illumination of the white light 112 initially emitted from the light source module 110.

As described above, in order to solve the problem of the large scale light spot, in the conventional technique, the characteristic, such as the geometry shape and the curvature of the second integral lens array 130 is designed according to the distribution of the light spots after the white light 112 had passed through the first integral lens array 120 to control the scale of the light spot formed by focusing the white light 112 to focus on the polarization beam splitter converter 140.

FIG. 2 is a distribution diagram of the light spots when the white light emits onto the polarization beam splitter converter. Referring to FIG. 2, the polarization beam splitter converter 140 comprises a plurality of transparent regions 142 and a plurality of opaque regions 144 that are vertically interlaced with each other, and the white light is mainly focused on the transparent regions 142. Although the light spots formed by focusing the white light (i.e. the black dots in the diagram) mainly fall on the transparent regions 142, some light spots falling on the opaque regions 144 can't pass through the polarization beam splitter converter 140 and the light utilization of the illumination system 100 cannot be effectively improved. It is to be noted that some light spots, particularly the light spots spanning a wide range on X-axis falls in the opaque regions 144.

In addition, since the design of the second integral lens array 130 needs to correspond to the first integral lens array 120, the design of the integral lens array is complicated accordingly. Moreover, since the first integral lens array 120 and the second integral lens array 130 having different parameters, respectively, should be used in the illumination system 100, the manufacturing cost of the illumination system is inevitably increased. Furthermore, since the illumination system is symmetrical only to the center optical axis in the assembly, the illumination system is hard to mass-produce with rising manufacturing cost.

### SUMMARY OF THE INVENTION

Therefore, it is an objective of the present invention to provide an illumination system and a projection system with better light utilization.

In order to achieve the objective mentioned above and others, the present invention provides an illumination system. The illumination system comprises a light source module, a first integral lens array, a cylindrical lens array, a polarization beam splitter converter, a cylindrical lens, a condenser lens, and a collimator lens. The light source module is suitable for providing a white light, and the first integral lens array is disposed on an optical path of the white light. The cylindrical lens array is disposed on the optical path of the white light after the first integral lens array. The polarization beam splitter converter is disposed on the optical path of the white light after the cylindrical lens array. The cylindrical lens array is disposed on the optical path of the white light after the polarization beam splitter converter. The condenser lens is disposed on the optical path of the white light after the cylindrical lens array. The collimator lens is disposed on the optical path of the white light after the collimator lens.

In an embodiment of the present invention, the illumination system further comprises a second integral lens array, wherein the second integral lens array is disposed on the optical path between the first integral lens array and the cylindrical lens array.

In an embodiment of the present invention, the radius of each cylindrical lens in the cylindrical lens array is between 5 to 35 mm.

In order to achieve the objectives mentioned above and others, the present invention further provides a projection system. The projection system comprises an illumination system and a liquid crystal display panel. The illumination system comprises a light source module, a first integral lens array, a cylindrical lens array, a polarization beam splitter converter, a cylindrical lens, a condenser lens, and a collimator lens. The light source module is suitable for providing a white light, and the first integral lens array is disposed on an optical path of the white light. The cylindrical lens array is disposed on the optical path of the white light after the first integral lens array. The polarization beam splitter converter is disposed on the optical path of the white light after the cylindrical lens array. The cylindrical lens array is disposed on the optical path of the white light after the polarization beam splitter converter. The condenser lens is disposed on the optical path of the white light after the cylindrical lens array. The collimator lens is disposed on the optical path of the white light after the collimator lens. The liquid crystal display panel is disposed on the optical path after the illumination system.

In an embodiment of the present invention, the illumination system further comprises a second integral lens array, wherein the second integral lens array is disposed on the optical path between the first integral lens array and the cylindrical lens array.

In an embodiment of the present invention, the radius of each cylindrical lens in the cylindrical lens array is between 5 to 35 mm.

In an embodiment of the present invention, the liquid crystal display panel is a reflective liquid crystal display panel or a transmissive liquid crystal display panel. In addition, the reflective liquid crystal display panel is a LCOS (Liquid Crystal On Silicon) display panel.

In summary, in the illumination system and the projection system provided by the present invention, the cylindrical lens array can reduce the geometry length of the light spot in X-axis, such that the scale of the light spot can correspond to the scale of the transparent region of the polarization beam splitter converter. Accordingly, the present invention can effectively improve the light utilization of the illumination system and the projection system, with better quality product applying such illumination system and the projection system.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic side view of a conventional illumination system.

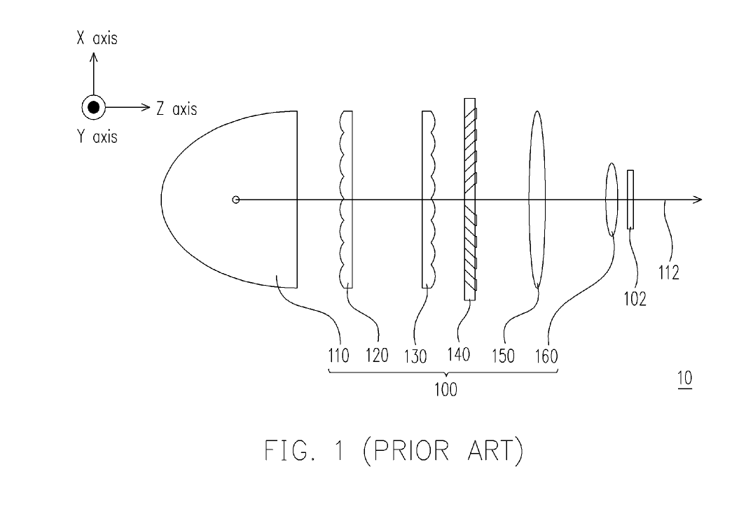

FIG. 2 is a distribution diagram of the light spots when the white light emits onto the polarization beam splitter converter.

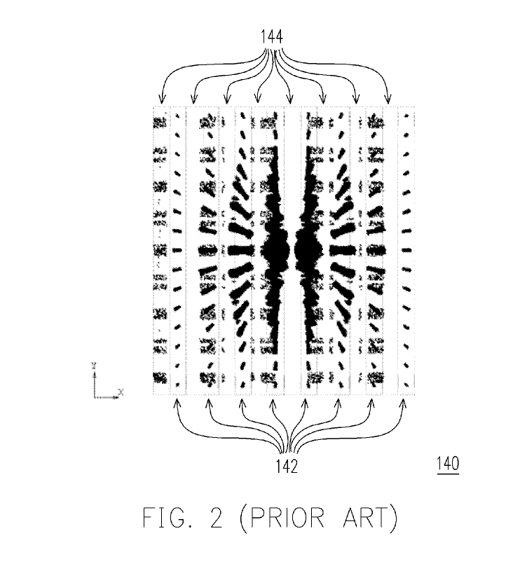

FIG. 3 is a schematic side view of a projection system according to an embodiment of the present invention.

FIG. 4 schematically illustrates a partial 3D view of the first integral lens array according to an embodiment of the present invention.

FIGS. 5A and 5B schematically illustrates a partial 3D view and a partial top view of the polarization beam splitter converter according to an embodiment of the present invention, respectively.

FIG. 6 schematically illustrates a partial 3D view of the cylindrical lens array according to an embodiment of the present invention.

FIG. 7 is a distribution diagram of the light spots when the white light emits onto the polarization beam splitter converter.

### DESCRIPTION PREFERRED EMBODIMENTS

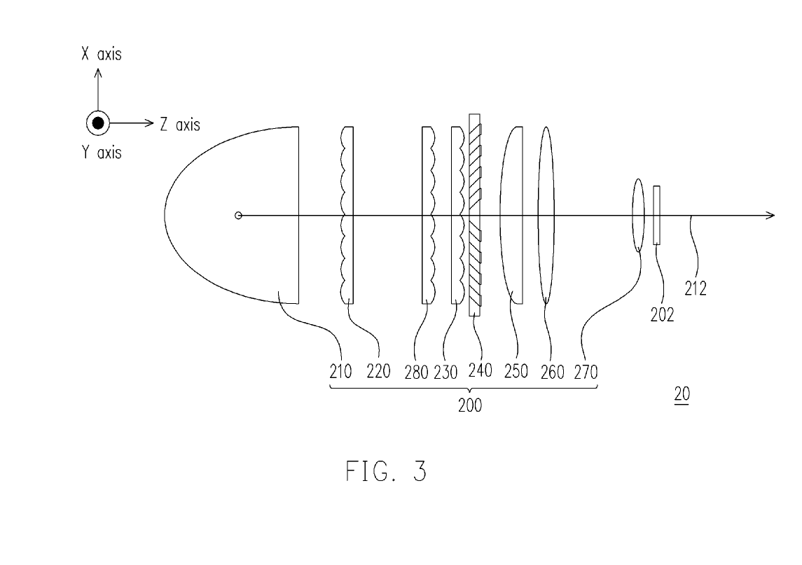

FIG. 3 is a schematic side view of a projection system according to an embodiment of the present invention. Referring to FIG. 3, the projection system 20 of the present invention comprises an illumination system 200 and a liquid crystal display panel 202. The illumination system 200 comprises a light source module 210, a first integral lens array 220, a cylindrical lens array 230, a polarization beam splitter converter 240, a cylindrical lens 250, a condenser lens 260, and a collimator lens 270 wherein the light source module 210 is suitable for providing a white light 212, and the first integral lens array 220, the cylindrical lens array 230, the polarization beam splitter converter 240, the cylindrical lens 250, the condenser lens 260, and the collimator lens 270 are sequentially disposed on the optical path of the white light 212.

Firstly, the white light 212 is focused on the polarization beam splitter converter 240 by the first integral lens array 220 and the cylindrical lens array 230, wherein the cylindrical lens array 230 specially reduces the geometry length of the light spot formed by focusing the white light 212 in the horizontal direction (i.e. X-axis) for the light spot to nearly completely pass through the polarization beam splitter converter 240. In the next step, the polarization beam splitter converter 240 converts the white light 212 into a polarized light, and the cylindrical lens 250 rectifies the light spot with an asymmetric shape (i.e. asymmetric X and Y directions) into a light spot with a desired shape and scale. The following step is that the white light 212 is focused on the collimator lens 270 by the condenser lens 260 again, and the collimator lens 270 is suitable for converting the white light 212 into a nearly parallel light beam.

As described above, since after the white light 212 is focused on the polarization beam splitter converter 240, the scale of the light spot can nearly completely pass through the polarization beam splitter converter 240, the present invention can effectively improve the light utilization of the illumination system 200. The light utilization is the ultimate ratio of the illumination of the white light 212 provided by the illumination system 200 to the illumination of the white light 212 initially emitted from the light source module 210. In addition, in the projection system 20 of the present invention, the liquid crystal display panel 202 is disposed on the optical path of the white light 212 provided by the illumination system 200, such that the white light 212 can be first converted into an imaged and then projected. Since the illumination system 200 provides better light utilization, the projection system 20 having the illumination system 200 provides better light utilization. The liquid crystal display panel 202 is a reflective liquid crystal display panel or a transmissive liquid crystal display panel and the reflective liquid crystal display panel is a LCOS (Liquid Crystal On Silicon) display panel.

The configuration of the first integral lens array 220, the cylindrical lens array 230, and the polarization beam splitter converter 240 in the illumination system 200 is described in greater detail with referring to the accompanying drawings hereinafter.

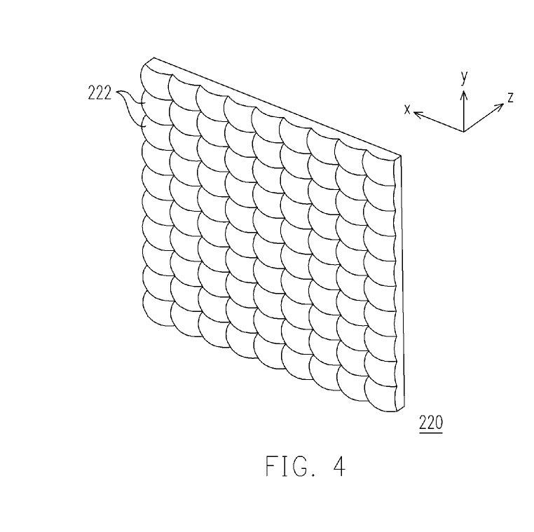

FIG. 4 schematically shows a partial 3D view of the first integral lens array according to an embodiment of the present invention. Referring to FIG. 4, the first integral lens array 220 is composed of lens units 222, disposed with a certain vertical and horizontal arrangement. When the white light 212 is emitted onto the first integral lens array 220, the white light 212 is focused into a plurality of light spots by the lens units 222, and the shape and scale of the light spots are determined by the factor such as the curvature of each lens unit 222. In addition, the quality of the lens units 222 corresponds to the resolution of the liquid crystal display panel 202. If the resolution of the liquid crystal display panel 202 is 1800×480, the first integral lens array 20 is formed by 480 rows by 1800 columns of the lens units 222.

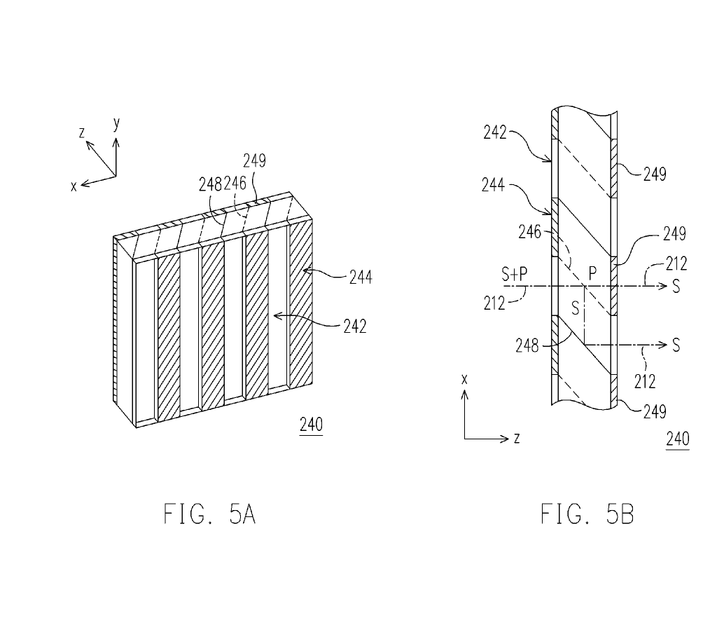

FIGS. 5A and 5B schematically illustrate a partial 3D view and a partial top view of the polarization beam splitter converter according to an embodiment of the present invention, respectively. Referring to FIGS. 5A and 5B, a plurality of transparent regions 242 and a plurality of opaque regions 244, vertical/horizontal interlacedly with each other, are disposed on an incident surface (relative to the moving direction of the white light 212) of the polarization beam splitter converter 240. In addition, a plurality of polarized light separation films 246 and a plurality of reflecting films 248 are slantingly disposed inside the polarization beam splitter converter 240, and a plurality of half-wave plates 249 is disposed on an emergence surface of the polarization beam splitter converter 240.

When the white light 212 with both p and s polarization states is emitted onto the polarization beam splitter converter 240 through the transparent region 242, the polarized light separation film 246 is suitable for freely passing through the white light 212 with the p polarization state and reflecting the white light 212 with the s polarization state. After being reflected by the reflecting film 248, the white light 212 with the s polarization state is directly emerged from the emergence surface of the polarization beam splitter converter 240. The white light 212 with the p polarization state is converted into the white light 212 with the s polarization state by the half-wave plate 249. Accordingly, the polarization state of the white light 112 is converted into a polarization state of single polarization direction.

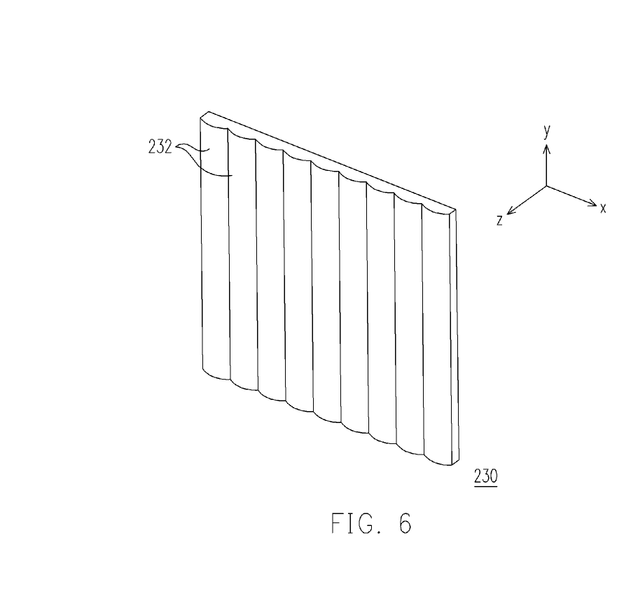

FIG. 6 schematically shows a partial 3D view of the cylindrical lens array according to an embodiment of the present invention. Referring to FIG. 6, the cylindrical lens array 230 is composed of a plurality of cylindrical lens 232 disposed in the horizontal direction. In the present embodiment, the preferable radius of each cylindrical lens 232 in X-axis is from 5 to 35 mm and preferably no curvature in Y-axis. When the light spot formed by the focused white light 112 emits onto the cylindrical lens array 230, each cylindrical lens 232 can reduce the geometry length of the light spot in X-axis and does not change the geometry length of the light spot in Y-axis, such that the range of the light spot is roughly the same as the range of the transparent region 242 in the polarization beam splitter converter 240. In addition, the curvature of the cylindrical lens 250 (as illustrated in FIG. 3) corresponds to that of cylindrical lens 232 in the cylindrical lens array 230, respectively, such that the asymmetric shape of the light spot previously passed through the cylindrical lens array 230 is rectified to the original shape by the cylindrical lens 250 as illustrated in FIG. 3.

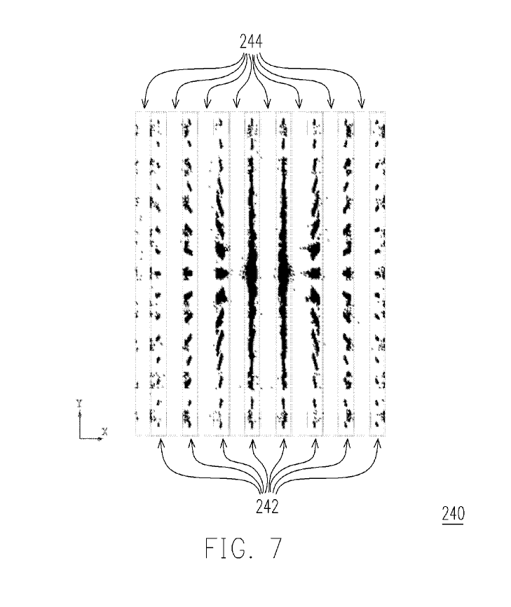

FIG. 7 is a distribution diagram of the light spots when the white light emits onto the polarization beam splitter converter. Referring to FIG. 7, in the illumination system 200 of the present invention, the light spot formed by the focused white light 212 (the black dot) nearly completely falls in the transparent region 242 of the polarization beam splitter converter 240. Accordingly, the present invention can effectively improve the light utilization of the illumination system 200.

TABLE 1

| Radius of cylindrical lens in cylindrical lens | |
|---|---|
| array | Light utilization |
| 5 | 97.10% |
| 10 | 96.66% |
| 15 | 95.01% |
| 20 | 94.13% |
| 25 | 93.62% |
| 30 | 93.26% |
| 35 | 92.99% |
| Conventional illumination system where | 91.48% |
| cylindrical lens array is not installed | |

Table 1 provides description of the relationship between the light utilization and the curvature of the cylindrical lens in the cylindrical lens array. Referring to table 1, when the radius of the cylindrical lens 232 in the cylindrical lens array 230 is between 5 to 25 mm, the light utilization of the illumination system 200 provided by the present invention 200 are higher than the conventional illumination system where the cylindrical lens array is not installed (91.48%) and the light utilization is a ratio of the illumination of the white light finally provided by the illumination system to the illumination of the white light initially emitted from the light source module. Considering the manufacturing cost and light emitting effect, the optimal curvature of the cylindrical lens 232 in the cylindrical lens array 230 is 20 mm.

Referring to FIG. 3, in order to further improve the light utilization of the illumination system 200, a second integral lens array 280 is further disposed in the present invention wherein the second integral lens array 280 is disposed on the optical path of the white light 212 between the first integral lens array 220 and the cylindrical lens array 230. By means of the first integral lens array 220, the second integral lens array 280 and the cylindrical lens array 230, the range of the light spot formed by focusing the white light 212 can further correspond to the transparent region 242 of the polarization beam splitter converter 240, such that the illumination system 200 of the present invention can provide a better light utilization. Since the illumination system 200 is not assembled as symmetrical to the center light axis, it is very easy to assemble the illumination system 200 in the mass production with lower manufacturing cost.

In summary, the illumination system and the projection system of the present invention at least have following advantages:

1. A cylindrical lens array is disposed in the present invention to adjust the shape of the light spot, such that the light spot can nearly completely pass through the polarization beam splitter converter with the illumination system of better light utilization. In addition, since the illumination system with a better light utilization is disposed in the projection system, the projection system of the present invention can provide better light utilization.

2. Comparing to the conventional technique where a second integral lens array with a special specification has to be installed, the light spot is rectified by the cooperation of the cylindrical lens array and the cylindrical lens in the present invention. A second integral lens array with a common specification is used in the present invention to replace the second integral lens array with a special specification, such that the manufacturing cost is reduced.

3. Since the illumination system of the present invention is not assembled as symmetrical to the center light axis, it is very easy to assemble the illumination system 200 in the mass production with lower manufacturing cost.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. An illumination system, comprising:
a light source module suitable for providing a white light;
a first integral lens array disposed on a optical path of the white light;
a cylindrical lens array disposed on the optical path of the white light after the first integral lens array;
a polarization beam splitter converter disposed on the optical path of the white light after the cylindrical lens array;
a cylindrical lens disposed on the optical path of the white light after the polarization beam splitter converter;
a condenser lens disposed on the optical path of the white light after the cylindrical lens; and
a collimator lens disposed on the optical path of the white light after the condenser lens.

2. The illumination system of claim 1, further comprising a second integral lens array disposed on the optical path of the white light between the first integral lens array and the cylindrical lens array.

3. The illumination system of claim 1, wherein the radius of each cylindrical lens in the cylindrical lens array is from 5 to 35 mm.

4. A projection system, comprising:
an illumination system, comprising:
a light source module suitable for providing a white light;
a first integral lens array disposed on a optical path of the white light;
a cylindrical lens array disposed on the optical path of the white light after the first integral lens array;
a polarization beam splitter converter disposed on the optical path of the white light after the cylindrical lens array;
a cylindrical lens disposed on the optical path of the white light after the polarization beam splitter converter;
a condenser lens disposed on the optical path of the white light after the cylindrical lens; and
a collimator lens disposed on the optical path of the white light after the condenser lens; and
a liquid crystal display panel disposed on the optical path after the illumination system.

5. The projection system of claim 4, wherein the illumination system further comprises a second integral lens array disposed on the optical path of the white light between the first integral lens array and the cylindrical lens array.

6. The projection system of claim 4, wherein the radius of each cylindrical lens in the cylindrical lens array is from 5 to 35 mm.

7. The projection system of claim 4, wherein the liquid crystal display panel is a reflective liquid crystal display panel or a transmissive liquid crystal display panel.

8. The projection system of claim 7, wherein the reflective liquid crystal display panel is a LCOS (Liquid Crystal On Silicon) display panel.
